(19) United States
(12) Patent Application Publication
(10) Pub. No.: US 2025/0108871 A1
(43) Pub. Date: Apr. 3, 2025

(54) VEHICLE FRONT END DESIGN

(71) Applicant: Ford Global Technologies, LLC, Dearborn, MI (US)

(72) Inventors: S.M. Iskander Farooq, Novi, MI (US); Mohammad Omar Faruque, Ann Arbor, MI (US); Geeta Rani, Canton, MI (US); Dean M. Jaradi, Macomb, MI (US)

(73) Assignee: Ford Global Technologies, LLC, Dearborn, MI (US)

(21) Appl. No.: 18/479,919

(22) Filed: Oct. 3, 2023

(51) Int. Cl. B62D 65/00; B62D 21/15

(52) U.S. Cl. CPC B62D 65/00; B62D 21/152

(57) ABSTRACT

A computer includes a processor and a memory, and the memory stores instructions executable by the processor to receive a plurality of proposed longitudinal distances for a vehicle being designed and determine a predicted metric of a predefined frontal impact to the vehicle using the proposed longitudinal distances. The proposed longitudinal distances are measured along a longitudinal axis of the vehicle between structural landmarks in a front end of the vehicle.

### BACKGROUND

Certain frontal impacts to vehicles may be simulated with tests, e.g., a frontal impact test, a frontal oblique impact test, small offset rigid barrier (SORB) test, etc. As one example, the National Highway Traffic Safety Administration (NHTSA) sets a standard for a frontal test in which the vehicle impacts a rigid barrier while traveling forward at 35 miles/hour.

### BRIEF DESCRIPTION OF THE DRAWINGS

FIG. 1 is a block diagram of an example computer.

FIG. 2 is a diagrammatic side view of a portion of a body of an example vehicle.

FIG. 3 is a plot of acceleration of the vehicle during an example predefined frontal impact.

FIG. 4 is a plot of dynamic compression of the vehicle during the predefined frontal impact.

FIG. 5 is a diagram of a spring-mass system characterizing the vehicle during the predefined frontal impact.

FIG. 6 is a screenshot of an input screen of an application for determining a predicted metric of the predefined frontal impact to the vehicle.

FIG. 7 is a screenshot of a selection screen of the application.

FIG. 8 is a screenshot of an output screen of the application.

FIG. 9 is a flowchart of an example process for determining the predicted metric of the predefined frontal impact to the vehicle.

FIG. 10 is a flowchart of an example process for designing and manufacturing the front end of the vehicle.

### DETAILED DESCRIPTION

This disclosure describes techniques for evaluating and revising an initial design for a front end of a vehicle early in the design process, speeding the design process and determining features that may be incorporated into the manufactured vehicle. For example, the techniques herein may be used after the design of the exterior styling of the front end but before the creation of three-dimensional models of interior frame members and components. A computer is programmed to receive a plurality of proposed longitudinal distances for a vehicle being designed and determine a predicted metric of a predefined frontal impact to the vehicle using the proposed longitudinal distances. The proposed longitudinal distances are measured along a longitudinal axis of the vehicle between structural landmarks in a front end of the vehicle, e.g., between a front bumper of the vehicle and a front side of an engine of the vehicle, between the front side of the engine and a rear side of the engine, and between the rear side of the engine and a passenger compartment of the vehicle. These techniques can identify a need to change longitudinal distances in the design of the vehicle even before creating a three-dimensional model of the front end of the vehicle, instead of expending the effort to create a three-dimensional model that may need to be revised after, e.g., running a simulation of a frontal-impact test on the three-dimensional model. Moreover, determining the predicted metric of a frontal impact can be performed with a reasonably high accuracy with only the proposed longitudinal distances, resulting in an initial design that is more likely to pass more detailed simulations and tests later in the design process.

A computer includes a processor and a memory, and the memory stores instructions executable by the processor to receive a plurality of proposed longitudinal distances for a vehicle being designed and determine a predicted metric of a predefined frontal impact to the vehicle using the proposed longitudinal distances. The proposed longitudinal distances are measured along a longitudinal axis of the vehicle between structural landmarks in a front end of the vehicle.

In an example, the instructions may further include instructions to determine the predicted metric of the predefined frontal impact using the proposed longitudinal distances and without using vertical or lateral dimensions of the vehicle.

In an example, the proposed longitudinal distances may include a proposed first longitudinal distance between a front bumper of the vehicle and a front side of an engine of the vehicle. In a further example, the instructions may further include instructions to determine a revised first longitudinal distance between the front bumper and the front side of the engine based on the predicted metric.

In an example, the proposed longitudinal distances may include a proposed second longitudinal distance between a front side of an engine of the vehicle and a rear side of the engine.

In an example, the proposed longitudinal distances may include a proposed third longitudinal distance between a rear side of an engine of the vehicle and a passenger compartment of the vehicle.

In an example, the instructions may further include instructions to determine an available compression distance, the available compression distance being a difference between a sum of the proposed longitudinal distances and an estimated stack-up, the estimated stack-up being a sum of products of each proposed longitudinal distance with a respective compression percentage. In a further example, the instructions may further include instructions to determine the predicted metric of the predefined frontal impact using the available compression distance.

In another further example, the instructions may further include instructions to select at least one of the compression percentages according to an input indicating whether the vehicle is a battery-electric vehicle or an internal-combustion-engine vehicle.

In another further example, at least two of the compression percentages may be different from one another.

In another further example, the instructions may further include instructions to determine a maximum dynamic compression distance based on a target vehicle pulse index, and in response to the maximum dynamic compression distance exceeding the available compression distance, determine a revised longitudinal distance, the revised longitudinal distance corresponding to the same structural landmarks as one of the proposed longitudinal distances.

In an example, the instructions may further include instructions to determine a maximum dynamic compression distance for the front end of the vehicle during the predefined frontal impact based on a target vehicle pulse index. In a further example, the instructions may further include instructions to receive the target vehicle pulse index as a user-selected input.

In an example, the instructions may further include instructions to determine a predicted vehicle pulse index of the predefined frontal impact using the proposed longitudinal distances. In a further example, the predicted vehicle pulse index may be maximum value of acceleration of a mass in a spring-mass system.

In another further example, the instructions may further include instructions to determine the predicted vehicle pulse index using the proposed longitudinal distances and a proposed vehicle mass of the vehicle.

In another further example, the instructions may further include instructions to determine the predicted vehicle pulse index based on the proposed longitudinal distances and a proposed engine mass of an engine of the vehicle.

In another further example, the instructions may further include instructions to determine an idealized two-step pulse characterizing the predefined frontal impact based on the proposed longitudinal distances, and determine the predicted vehicle pulse index based on the idealized two-step pulse.

In an example, the instructions may further include instructions to determine an idealized two-step pulse characterizing the predefined frontal impact based on the proposed longitudinal distances.

A method includes receiving a plurality of proposed longitudinal distances for a vehicle being designed and determining a predicted metric of a predefined frontal impact to the vehicle using the proposed longitudinal distances. The proposed longitudinal distances are measured along a longitudinal axis of the vehicle between structural landmarks in a front end of the vehicle.

With reference to the Figures, wherein like numerals indicate like parts throughout the several views, a computer 100 includes a processor 105 and a memory 110, and the memory 110 stores instructions executable by the processor 105 to receive a plurality of proposed longitudinal distances D1, D2, D3 for a vehicle 200 being designed and determine a predicted metric of a predefined frontal impact to the vehicle 200 using the proposed longitudinal distances D1, D2, D3. The proposed longitudinal distances D1, D2, D3 are measured along a longitudinal axis L of the vehicle 200 between structural landmarks in a front end 205 of the vehicle 200.

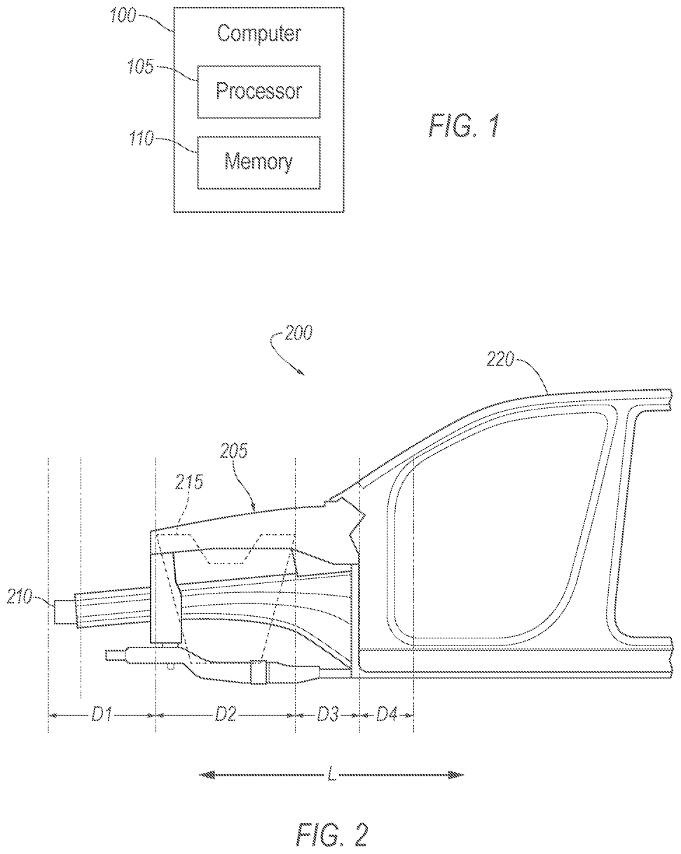

With reference to FIG. 1, the computer 100 is a microprocessor-based computing device, e.g., a generic computing device including the processor 105 and the memory 110. The memory 110 of the computer 100 can include media for storing instructions executable by the processor 105 as well as for electronically storing data and/or databases, and/or the computer 100 can include structures such as the foregoing by which programming is provided. The computer 100 can be multiple computers coupled together.

With reference to FIG. 2, the vehicle 200 being designed may be any passenger or commercial automobile such as a car, a truck, a sport utility vehicle, a crossover, a van, a minivan, a taxi, a bus, etc. Although FIG. 2 shows structural details of a frame of the vehicle 200, such details may not necessarily have been designed yet.

The techniques below rely on a plurality of longitudinal distances D1, D2, D3 from the vehicle 200. The longitudinal distances D1, D2, D3 are measured along a longitudinal axis L of the vehicle 200 between structural landmarks in the front end 205 of the vehicle 200. The term “longitudinal axis” is used herein in its conventional automotive sense of an axis running lengthwise along the vehicle 200, i.e., along the forward-rearward directions relative to the vehicle 200. For the purposes of this disclosure, a “structural landmark” is defined as a location on a vehicle defined according to a structural feature of the vehicle at that location. The longitudinal distances D1, D2, D3 may be consecutive, i.e., each longitudinal distance D1, D2, D3 may be connected to adjacent longitudinal distance(s) D1, D2, D3 at their endpoint(s). Thus, a sum of the longitudinal distances D1, D2, D3 may be a longitudinal length from a frontmost of the structural landmarks to a rearmost of the structural landmarks, e.g., a longitudinal length of the front end 205 of the vehicle 200.

The longitudinal distances D1, D2, D3 may include a first longitudinal distance D1, a second longitudinal distance D2, and a third longitudinal distance D3. The first longitudinal distance D1 may extend between a front bumper 210 of the vehicle 200 and a front side of an engine 215 of the vehicle 200, e.g., between a forwardmost point of the front end 205 and a forwardmost point of the engine 215. The second longitudinal distance D2 may extend between the front side of the engine 215 and a rear side of the engine 215, e.g., between the forwardmost point of the engine 215 and a rearwardmost point of the engine 215. The third longitudinal distance D3 may extend between the rear side of the engine 215 and a passenger compartment 220 of the vehicle 200, e.g., between the rearwardmost point of the engine 215 and a forwardmost point of the passenger compartment 220. The use of these specific longitudinal distances D1, D2, D3 is beneficial because the longitudinal distances D1, D2, D3 define longitudinal regions of the front end 205 that typically behave differently from each other during certain frontal impacts, e.g., that exhibit more or less compression during such frontal impacts.

The computer 100 is programmed to receive a plurality of proposed longitudinal distances D1, D2, D3 for the vehicle 200. The descriptor “proposed” indicates that the longitudinal distances D1, D2, D3 are taken from a design for the vehicle 200 before the techniques herein are applied. For example, a user may provide the proposed longitudinal distances D1, D2, D3 as inputs to the computer 100.

The longitudinal distances D1, D2, D3 may have respective associated compression percentages. Each compression percentage is chosen to estimate how much the longitudinal region covered by the respective longitudinal distance D1, D2, D3 will typically compress in a predefined frontal impact. The predefined frontal impact is a hypothetical impact to a front end of a vehicle with situational characteristics such as speeds and positions defined in advance, e.g., according to a standard for a specific frontal-impact test. The compression percentages may be derived from historical data of the specific frontal-impact test. At least two of the compression percentages are different from one another; i.e., the longitudinal regions covered by the longitudinal distances D1. D2. D3 are estimated to exhibit different behavior during the predefined frontal impact. For example, a first compression percentage for the first longitudinal distance D1 may be 90%, a second compression percentage for the second longitudinal distance D2 may be 5%, and a third compression percentage for the third longitudinal distance D3 may be 90%. The computer 100 may store the compression percentages in the memory 110.

The computer 100 may be programmed to select at least one of the compression percentages according to an input indicating whether the vehicle 200 is a battery-electric vehicle or an internal-combustion-engine vehicle. The compression percentage being selected may correspond to a longitudinal region in which batteries of a battery-electric vehicle would be located, e.g., the longitudinal region covered by the third longitudinal distance D3. The computer 100 may store two third compression percentages, e.g., 5% for a battery-electric vehicle and 90% for an internal-combustion-engine vehicle.

The computer 100 may be programmed to determine an available compression distance, which represents an estimated total compression of the front end 205 during the predefined frontal impact. The available compression distance may be a difference between a sum of the proposed longitudinal distances D1, D2, D3 and an estimated stack-up. The sum of the proposed longitudinal distances D1, D2, D3 may be the longitudinal length of the front end 205 of the vehicle 200, possibly also including an acceptable longitudinal deformation D4 of the front of the passenger compartment 220 during the predefined frontal impact. A designer may set the fourth longitudinal distance D4 to zero or to a small positive length depending on a design of the passenger compartment 220. The estimated stack-up may be an estimated longitudinal length of the front end 205 of the vehicle 200 after the predefined frontal impact. The estimated stack-up may be a sum of products of each proposed longitudinal distance with a respective compression percentage. For example, the available compression distance may be calculated from the following expression:

Dₐᵥ=(D1+D2+D3+D4)−((1−k₁)D1+(1−k₂)D2+(1−k₃)D3)

in which Day is the available compression distance and k₁, k₂, and k₃ are the respective compression percentages.

The computer 100 is programmed to determine a predicted metric of the predefined frontal impact to the vehicle 200. For the purposes of this disclosure, a “predicted metric” is defined as an estimation of a numerical quantity or collection of numerical quantities characterizing the effects of the predefined frontal impact. For example, the predicted metric may include an idealized two-step pulse, a dynamic compression distance, and/or a vehicle pulse index, which are interrelated concepts described in more detail below.

The computer 100 determines the predicted metric of the predefined frontal impact using the proposed longitudinal distances D1, D2, D3 and/or proposed masses of the vehicle 200 and/or the engine 215, as well as possibly the acceptable longitudinal deformation D4. The proposed vehicle mass Mv of the vehicle 200 and the proposed engine mass ME may be provided as inputs and may be chosen based on an initial design for exterior styling of the vehicle 200 and intended engine specifications of the vehicle 200. The computer 100 may use the proposed longitudinal distances D1, D2, D3 and acceptable longitudinal deformation D4 by using the available compression distance Dar. The computer 100 may determine the predicted metric without using vertical or lateral dimensions of the vehicle 200. The vertical dimensions of the vehicle 200 refer to measurements along the up-down directions relative to the vehicle 200, and the lateral dimensions refer to measurements along the left-right directions relative to the vehicle 200. For example, the computer 100 may determine the predicted metric without using a three-dimensional model of the vehicle 200, as such a model may not yet exist.

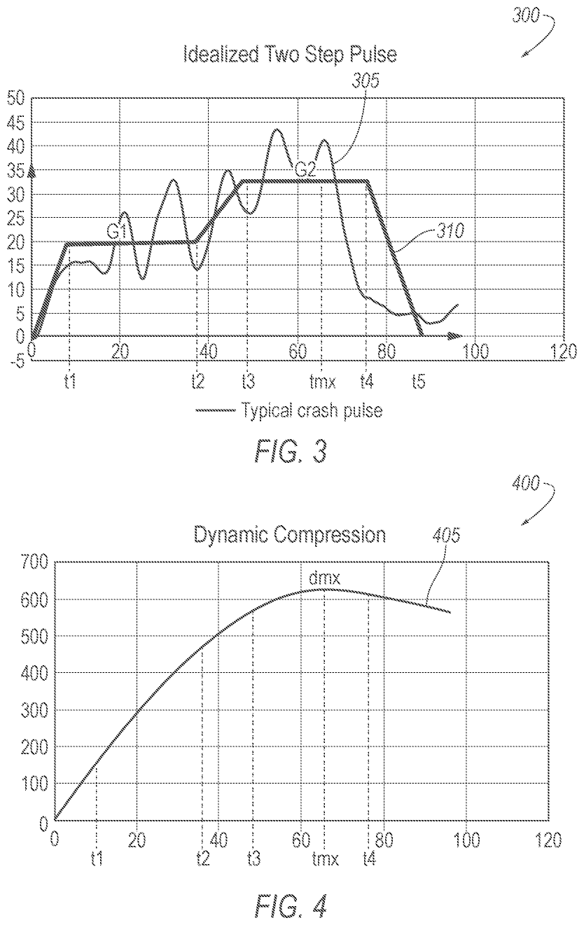

With reference to FIG. 3, the predicted metric may include an idealized two-step pulse characterizing the predefined frontal impact. FIG. 3 is a plot 300 showing the deceleration being applied to the front end 205 of the vehicle 200 during the predefined frontal impact versus time. FIG. 3 includes a first curve 305 showing an example actual pulse from the predefined frontal impact, i.e., the deceleration experienced by the vehicle 200 during the predefined frontal impact. The actual pulse is approximated with a second curve 310 made of linear segments, e.g., a continuous, piecewise-linear function. The second curve 310 is the idealized two-step pulse. The second curve 310 includes a first segment linearly increasing from a start time (i.e., t=0) to a first time 11, a second segment that is unchanging at a deceleration value G1 from the first time 11 to a second time 12, a third segment that is linearly increasing from the second time 12 to a third time 13, a fourth segment that is unchanging at a deceleration value G2 from the third time 13 to a fourth time 14, and a fifth segment that is linearly decreasing from the fourth time 14 to a fifth time 15. The deceleration value G2 is greater than the deceleration value G1. The second segment at the deceleration value G1 corresponds to the compression of the longitudinal region forward of the engine 215 during the predefined frontal impact, and the fourth segment at the deceleration value G2 corresponds to the compression of the longitudinal region between the engine 215 and the passenger compartment 220 during the predefined frontal impact. The times 11, 12, 13, 14, 15 may be determined from the proposed longitudinal distances D1, D2, D3, or the times 11, 12, 13, 14, 15 may be prestored in the memory 110 of the computer 100 since the times 11, 12, 13, 14, 15 have low variability.

With reference to FIG. 4, the predicted metric may include a dynamic compression distance. The dynamic compression distance represents the distance by which the vehicle 200 is compressed during the predefined frontal impact. FIG. 4 is a plot 400 showing the dynamic compression distance during the predefined frontal impact versus time. FIG. 4 includes a curve 405 approximating the dynamic compression distance. The dynamic compression distance is the second integral of the two-step pulse with respect to time. Because the idealized two-step pulse is a piecewise-linear function, if the idealized two-step pulse is known, the computer 100 may determine the dynamic compression distance over time using a simple formula of the deceleration values G1, G2 and the times 11, 12, 13, 14, 15. The dynamic compression distance reaches a maximum value dmx at a time tmx that is between the third time 13 and the fourth time 14, i.e., while the vehicle 200 is experiencing the maximum deceleration value G2.

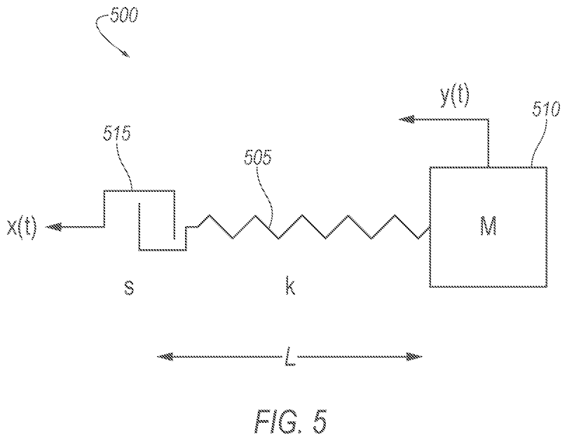

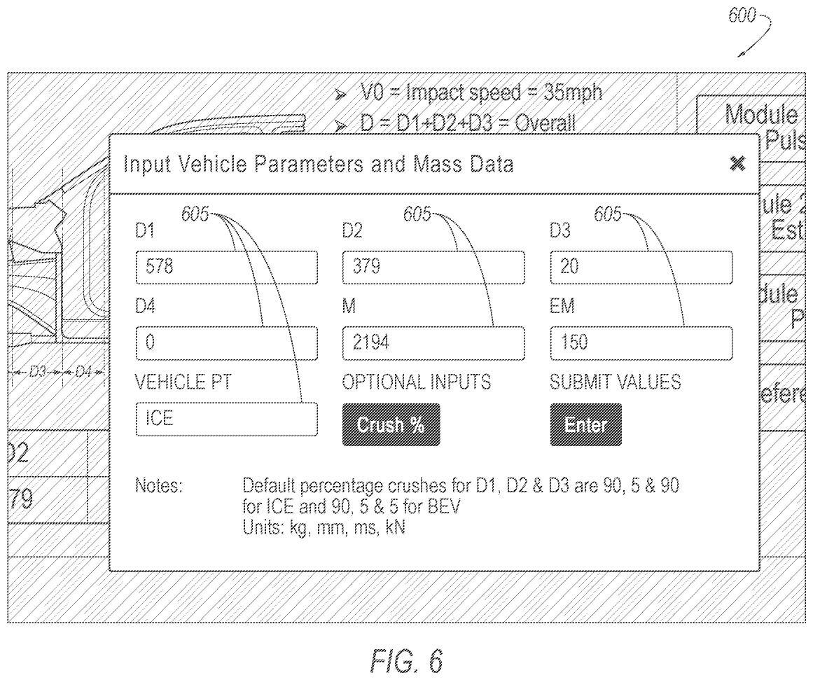

With reference to FIG. 5, the predicted metric may include a vehicle pulse index (VPI). The VPI is a measure of the deceleration experienced by the passenger compartment 220 of the vehicle 200. The VPI relies on modeling the vehicle 200 as a spring-mass system 500. The spring-mass system 500 includes a spring 505, a mass 510 connected to one end of the spring 505, and a slack 515 connected to the other end of the spring 505. The spring 505, the mass 510, and the slack 515 are idealized elements. The spring 505 applies a force equal to a product of a spring constant k and a compression or extension distance from a relaxed state. The mass 510 is a point with mass M. The slack 515 permits free movement of its ends up to a maximum distance s away from each other. A forcing function x(t) is applied to the slack 515, representing displacement of the free end of the slack 515. The dynamic compression distance may be used as the forcing function x(t). As a result, the mass 510 experiences an output displacement function y(t), representing displacement of the point mass 510. The forcing function x(t) is interpretable as the longitudinal displacement of the front bumper 210, and the output displacement function y(t) is interpretable as the longitudinal displacement of the passenger compartment 220. The spring-mass system 500 may be represented by a series of differential equations. For example, a sum of the acceleration force (the product of the mass M and the second time derivative of the output displacement function y(t)) and a spring force for the point mass 510 (the product of the spring constant k and the output displacement function y(t)) equals a dummy function, and the dummy function equals zero for the forcing function x(t) being less than the slack s and a spring force for the free end of the slack 515 (the product of the spring constant k and the difference between the forcing function x(t) and the slack s), e.g., the following:

$$M \ddot{y} + ky = P ( t )$$

$$P ( t ) = \{ \begin{matrix}0 , x < s \\ k ( x - s ) , x \geq s\end{matrix}$$

in which P (t) is the dummy function and two dots above a letter indicate a second derivative with respect to time t. The VPI equals the maximum value of the output acceleration of the mass 510, i.e., of the second derivative with respect to time t of the output displacement function y(t), as in the following expression:

VPI=max(ÿ)

With reference to FIGS. 6-8, the computer 100 may be programmed to prompt a user for inputs about the proposed design for the front end 205 of the vehicle 200 and to output quantities for the predicted metric of the predefined frontal impact to the front end 205. The computer 100 may execute one or more of a plurality of modules stored in the memory 110 of the computer 100. Each module may convert certain inputs about the proposed design into certain metrics for the predicted metric, and the inputs and metrics may be different between different modules.

With reference to FIG. 6, the computer 100 may be programmed to prompt the user for inputs, e.g., by displaying an input screen 600 including a plurality of fields 605. The computer 100 may be programmed to receive the inputs from the user, e.g., by the user typing values into the fields 605. The input screen 600 may include fields 605 for the proposed longitudinal distances D1, D2, D3, the acceptable longitudinal deformation D4, the proposed vehicle mass Mv of the vehicle 200, the proposed engine mass ME of the engine 215, whether the vehicle 200 is a battery-electric vehicle or an internal-combustion-engine vehicle, and an option whether to enter values for the compression percentages. If the user does not enter new values, the computer 100 may use default values for the compression percentages, as described above.

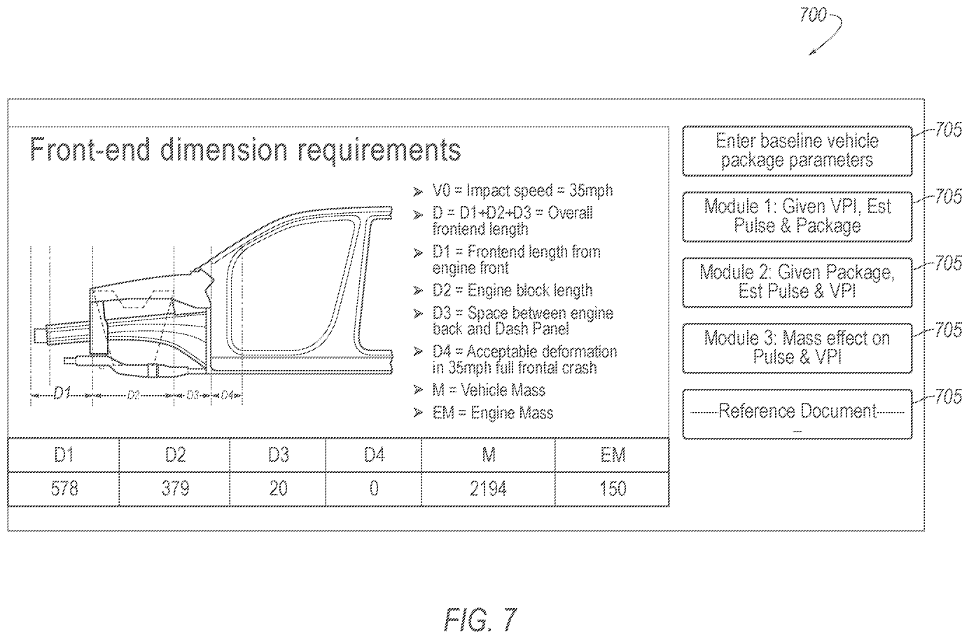

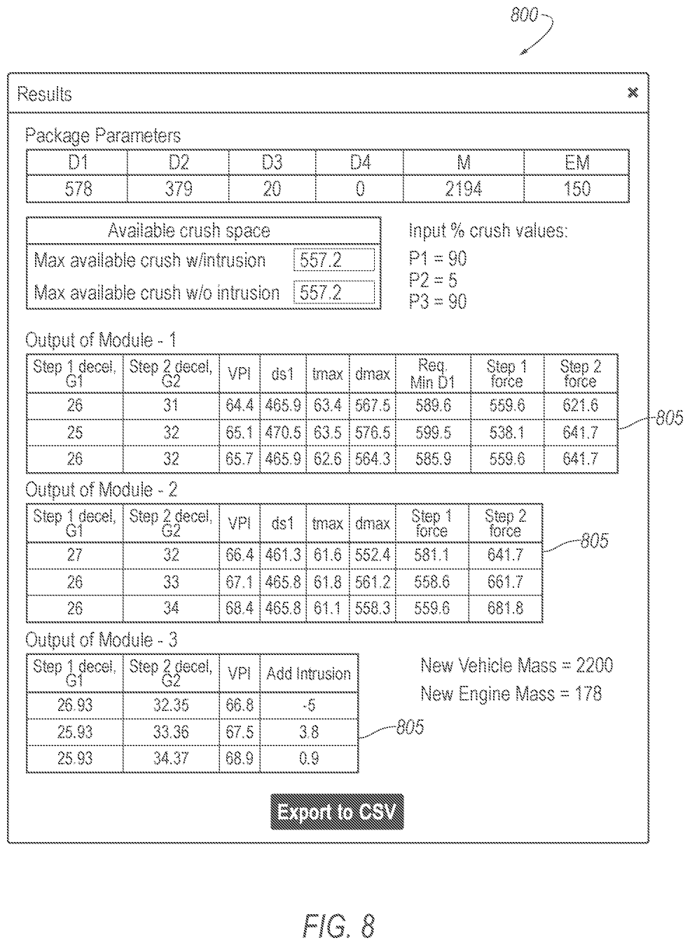

With reference to FIG. 7, the computer 100 may be programmed to prompt the user to select one of the modules, e.g., by displaying a selection screen 700, in response to receiving the inputs. The selection screen 700 may include a plurality of buttons 705 corresponding to the modules and possibly other options such as displaying reference materials or entering different values for the inputs. The modules may include a first module, a second module, and a third module.

With reference to FIG. 8, the computer 100 may be programmed to generate outputs for each module, e.g., by displaying an output screen 800 containing the outputs. The output screen 800 may include tables 805 for the respective modules.

The computer 100 may execute the second module in response to the user selecting the second module from the selection screen 700. The second module takes the proposed longitudinal distances D1, D2, D3, the acceptable longitudinal deformation D4, and the proposed masses Mv, ME as inputs. The second module outputs the idealized two-step pulse and the predicted vehicle pulse index (VPI).

When executing the second module, the computer 100 determines the idealized two-step pulse. Specifically, the computer 100 determines the deceleration values G1, G2 characterizing the idealized two-step pulse. For example, the computer 100 may perform a grid search over possible values for G1 and G2. The grid search attempts to find deceleration values G1, G2 for which the maximum value dmx for the dynamic compression distance equals the available compression distance Dₐᵥ, i.e., for which the predefined frontal impact compresses the front end 205 of the vehicle 200 by the maximum acceptable amount. In other words, the computer 100 determines how much the vehicle 200 must be decelerated so that the compression of the front end 205 stays within acceptable bounds. As described above, the available compression distance Day is determined using the proposed longitudinal distances D1, D2, D3. The grid search may be subject to physics-based constraints based on the known behavior of vehicles during the predefined frontal impacts, e.g., that the second deceleration value G2 is greater than the first deceleration value G1. The grid search may provide multiple sets of values for the deceleration values G1, G2, as indicated by the multiple rows in the table for the second module.

Next, when executing the second module, the computer 100 determines the predicted VPI based on the idealized two-step pulse. For example, the computer 100 determines the predicted VPI using the spring-mass system 500 described above with the idealized two-step pulse inputted as the forcing function x(t). Because the predicted VPI is based on the idealized two-step pulse, the predicted VPI is based indirectly on the proposed longitudinal distances D1, D2, D3. The predicted VPI is also based on the vehicle mass Mv and the engine mass ME. The mass M of the point mass 510 of the spring-mass system 500 may be set equal to the vehicle mass My during the first step of the pulse, e.g., M=Mv for t≤t2, and equal to the vehicle mass My minus the engine mass ME during the second step of the pulse, e.g., M=Mv−ME for t>t2. The computer 100 may use prestored values for the spring constant k and the slack s chosen based on typical values for the predefined frontal impacts. If the predicted VPI is within acceptable bounds, then it is likely possible to design the front end 205 of the vehicle 200 to provide acceptable compression and VPI using the proposed longitudinal distances D1, D2, D3. If the predicted VPI is not within acceptable bounds, then the user has the ability to choose new values for the longitudinal distances D1, D2, D3 before proceeding further in the design process.

The computer 100 may execute the first module in response to the user selecting the first module from the selection screen 700. The first module takes the proposed longitudinal distances D1, D2, D3 and the proposed masses Mv. ME as inputs, as well as a target VPI. The computer 100 may receive the target VPI as a user-selected input. For example, the computer 100 may prompt the user to enter the target VPI by displaying a fillable field in response to the user selecting the first module. The first module outputs the idealized two-step pulse, the maximum dynamic compression distance, and, if the maximum dynamic compression distance exceeds the available compression distance, a revised value for at least one of the longitudinal distances D1, D2, D3.

When executing the first module, the computer 100 determines the idealized two-step pulse. Specifically, the computer 100 determines the deceleration values G1, G2 characterizing the idealized two-step pulse. For example, the computer 100 may perform a grid search over possible values for G1 and G2. The grid search attempts to find deceleration values G1, G2 for which the predicted VPI is less than or equal to the target VPI, i.e., for which the predefined frontal impact decelerates the passenger compartment 220 by an acceptable amount. In other words, the computer 100 determines how much the front bumper 210 of the vehicle 200 must be decelerated so that the deceleration of the passenger compartment 220 stays within acceptable bounds. For each set of test deceleration values G1, G2, the computer 100 can determine the predicted VPI in the manner described above for the second module. The grid search may be subject to physics-based constraints based on the known behavior of vehicles during the predefined frontal impacts, e.g., that the second deceleration value G2 is greater than the first deceleration value G1. The grid search may provide multiple sets of values for the deceleration values G1, G2, as indicated by the multiple rows in the table for the first module.

Next, when executing the first module, the computer 100 determines the maximum dynamic compression distance dmx for the front end 205 of the vehicle 200 during the predefined frontal impact based on the idealized two-step pulse. The computer 100 determines the maximum dynamic compression distance dmx by integrating the two-step pulse twice and finding the maximum value of the resulting function, as described above. Because the maximum dynamic compression distance is based on the idealized two-step pulse, the maximum dynamic compression distance is based indirectly on the target VPI.

Next, when executing the first module, the computer 100 determines whether the maximum dynamic compression distance dmx exceeds the available compression distance Day i.e., whether dmx>Dₐᵥ.

In response to the maximum dynamic compression distance dmx exceeding the available compression distance Dₐᵥ, the computer 100 determines a revised value for at least one of the longitudinal distances D1, D2, D3, which will be referred to as a revised longitudinal distance D1′, D2′, D3′. The revised longitudinal distance D1′, D2′, D3′ corresponds to the same structural landmarks as a respective one of the proposed longitudinal distances D1, D2, D3. For example, the computer 100 may determine a revised first longitudinal distance D1′, i.e., a new value to replace the proposed first longitudinal distance D1 between the front bumper 210 and the front side of the engine 215. The computer 100 determines the revised longitudinal distance based on the predicted metric of the predefined frontal impact, e.g., based on the maximum dynamic compression distance dmx. For example, the computer 100 may set the revised first longitudinal distance D1′ equal to a sum of the proposed first longitudinal distance D1 and the difference between the maximum dynamic compression distance and the available compression distance, i.e., D1′=D1+(dmx−Dₐᵥ).

In response to the maximum dynamic compression distance dmx being less than the available compression distance Dₐᵥ, the computer 100 refrains from determining the revised longitudinal distance D1′, D2′, D3′.

The computer 100 may execute the third module in response to the user selecting the third module from the selection screen 700. The third module may be only available to the user after execution of the second module. The third module takes new proposed masses for the vehicle 200 and the engine 215 as inputs. The computer 100 may receive the new proposed masses as user-selected inputs. For example, the computer 100 may prompt the user to enter a new proposed vehicle mass and a new proposed engine mass by displaying corresponding fillable fields in response to the user selecting the third module. The third module outputs new values for the idealized two-step pulse and the predicted VPI. The computer 100 determines the idealized two-step pulse and the predicted VPI in the same manner as described above for the second module, but substituting the new proposed masses in place of the original proposed masses. The computer 100 also outputs a change to a longitudinal deformation of the passenger compartment 220.

When executing the third module, the computer 100 determines the change to the longitudinal deformation of the passenger compartment 220 resulting from the new proposed masses. The change to the longitudinal deformation is a change in how much the maximum dynamic compression distance dmx exceeds the available compression distance Dar, i.e., Δd_{PC}=(dmx_{new}−D_{av,new})−(dmx_{old}−D_{av,old}), in which the subscript old indicates the originally entered proposed masses and the subscript new indicates the proposed masses entered for the third module.

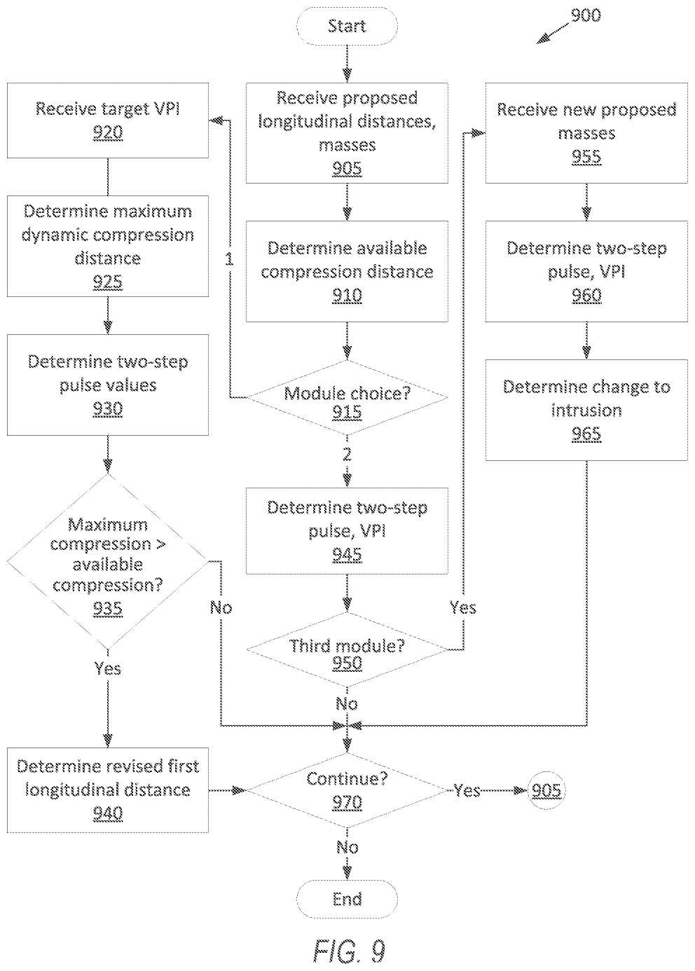

FIG. 9 is a flowchart illustrating an example process 900 for determining the predicted metric of the predefined frontal impact to the vehicle 200. The memory 110 of the computer 100 stores executable instructions for performing the steps of the process 900 and/or programming can be implemented in structures such as mentioned above. As a general overview of the process 900, the computer 100 receives the proposed longitudinal distances D1, D2, D3 and proposed masses Mv. ME and determines the available compression distance Dₐᵥ. In response to the user selecting the first module, the computer 100 receives the target VPI, determines the idealized two-step pulse, determines the maximum dynamic compression distance dmx, and if the maximum dynamic compression distance dmx exceeds the available compression distance Dₐᵥ, determines a revised first longitudinal distance D1′. In response to the user selecting the second module, the computer 100 determines the idealized two-step pulse and predicted VPI and permits the user to select the third module. In response to the user selecting the third module, the computer 100 receives new proposed masses Mv, ME, determines the idealized two-step pulse and predicted VPI, and determines a change to the longitudinal deformation Δd_{PC} of the passenger compartment 220. The user may choose to start over to enter new values for the proposed longitudinal distances D1, D2, D3 or proposed masses Mv, ME.

The process 900 begins in a block 905, in which the computer 100 receives the proposed longitudinal distances D1, D2, D3 and proposed masses Mv, ME, as described above.

Next, in a block 910, the computer 100 determines the available compression distance Dar, as described above.

Next, in a decision block 915, the computer 100 determines whether the user selected the first module or the second module. In response to the user selecting the first module, the process 900 proceeds to a block 920. In response to the user selecting the second module, the process 900 proceeds to a block 945.

In the block 920, the computer 100 receives the target VPI, as described above.

Next, in a block 925, the computer 100 determines the idealized two-step pulse, as described above.

Next, in a block 930, the computer 100 determines the maximum dynamic compression distance dmx, as described above.

Next, in a decision block 935, the computer 100 determines whether the maximum dynamic compression distance dmx is greater than the available compression distance Day. In response to the maximum dynamic compression distance dmx exceeding the available compression distance Dₐᵥ, the process 900 proceeds to a block 940. In response to the maximum dynamic compression distance dmx being below the available compression distance Dₐᵥ, the process 900 proceeds to a decision block 970.

In the block 940, the computer 100 determines the revised first longitudinal distance D1′, as described above. After the block 940, the process 900 proceeds to the decision block 970.

In the block 945, the computer 100 determines the idealized two-step pulse and the predicted VPI, as described above.

Next, in a decision block 950, the computer 100 determines whether the user selected the third module. In response to the user selecting the third module, the process 900 proceeds to a block 955. In response to the user making a different selection, the process 900 proceeds to the decision block 970.

In the block 955, the computer 100 receives a new proposed vehicle mass Mv and a new proposed engine mass ME, as described above.

Next, in a block 960, the computer 100 determines the idealized two-step pulse and the predicted VPI, as described above.

Next, in a block 965, the computer 100 determines the change to the longitudinal deformation Δd_{PC} of the passenger compartment 220, as described above. After the block 965, the process 900 proceeds to the decision block 970.

In the decision block 970, the computer 100 determines whether the user selected to continue using the application. In response to the user selecting to continue using the application, the process 900 returns to the block 905 to permit entry of new proposed longitudinal distances D1, D2, D3 and/or new proposed masses Mv. ME. In response to the user selecting to exit the application, the process 900 ends.

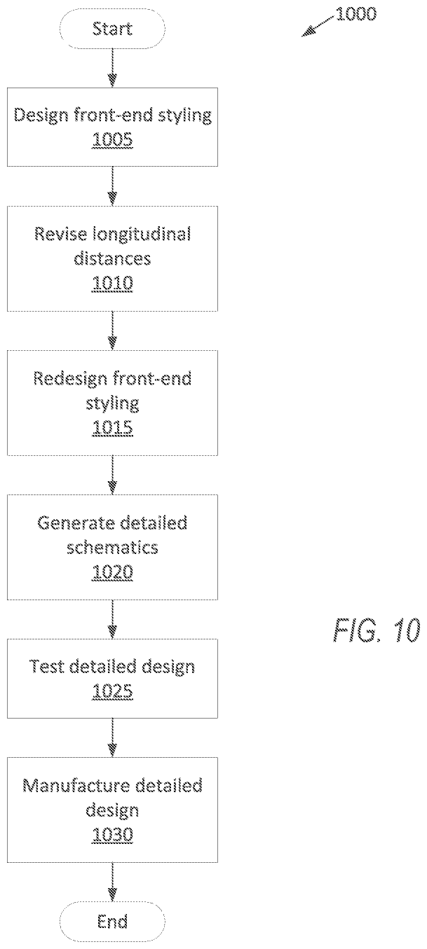

FIG. 10 is a flowchart illustrating an example process 1000 for designing and manufacturing the front end 205 of the vehicle 200. As a general overview of the process 1000, a designer or design team generates an initial design for the front end 205, revises the longitudinal distances D1, D2, D3 using the application described above, redesigns the front end 205 based on the revised longitudinal distances D1′, D2′, D3′, generates detailed schematics, tests the detailed design, and manufactures the vehicles according to the detailed design.

The process 1000 begins in a block 1005, in which some members of a design team generate an initial design. The initial design may still lack a three-dimensional model, e.g., may include basic styling and engine specifications but not details for other interior components and frame members.

Next, in a block 1010, some members of the design team may test and revise the proposed longitudinal distances D1, D2, D3 taken from the initial design using the application described above in the process 900. The design team may provide multiple iterations of proposed longitudinal distances D1, D2, D3 in order to arrive at revised longitudinal distances D1′, D2′, D3′.

Next, in a block 1015, some members of the design team revise the initial design to incorporate the revised longitudinal distances D1′, D2′, D3′.

Next, in a block 1020, some members of the design team generate a three-dimensional model of the front end 205 of the vehicle 200 from the revised initial design.

Next, in a block 1025, some members of the design team perform impact testing on the three-dimensional model or an actual vehicle built according to the three-dimensional model. The impact testing includes simulations of the predefined frontal impact to the vehicle 200, using the three-dimensional model, e.g., with finite element analysis (FEA). The impact testing further includes performing frontal-impact tests of the predefined frontal impact on actual vehicles, e.g., according to standards promulgated by, e.g., the National Highway Traffic Safety Administration (NHTSA), Insurance Institute for Highway Safety (IIHS), etc. The detailed design of the vehicle 200 may be revised as a result of the impact testing.

Next, in a block 1030, other members of the team manufacture the vehicle 200 according to the final detailed design. The revisions of the longitudinal distances D1, D2, D3 in the block 1010 therefore affect the design of the manufactured vehicle.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first,” “second,” and “third” are used throughout this document as identifiers and are not intended to signify importance, order, or quantity. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
receive a plurality of proposed longitudinal distances for a vehicle being designed, the proposed longitudinal distances being measured along a longitudinal axis of the vehicle between structural landmarks in a front end of the vehicle; and
determine a predicted metric of a predefined frontal impact to the vehicle using the proposed longitudinal distances.

2. The computer of claim 1, wherein the instructions further include instructions to determine the predicted metric of the predefined frontal impact using the proposed longitudinal distances and without using vertical or lateral dimensions of the vehicle.

3. The computer of claim 1, wherein the proposed longitudinal distances include a proposed first longitudinal distance between a front bumper of the vehicle and a front side of an engine of the vehicle.

4. The computer of claim 3, wherein the instructions further include instructions to determine a revised first longitudinal distance between the front bumper and the front side of the engine based on the predicted metric.

5. The computer of claim 1, wherein the proposed longitudinal distances include a proposed second longitudinal distance between a front side of an engine of the vehicle and a rear side of the engine.

6. The computer of claim 1, wherein the proposed longitudinal distances include a proposed third longitudinal distance between a rear side of an engine of the vehicle and a passenger compartment of the vehicle.

7. The computer of claim 1, wherein the instructions further include instructions to determine an available compression distance, the available compression distance being a difference between a sum of the proposed longitudinal distances and an estimated stack-up, the estimated stack-up being a sum of products of each proposed longitudinal distance with a respective compression percentage.

8. The computer of claim 7, wherein the instructions further include instructions to determine the predicted metric of the predefined frontal impact using the available compression distance.

9. The computer of claim 7, wherein the instructions further include instructions to select at least one of the compression percentages according to an input indicating whether the vehicle is a battery-electric vehicle or an internal-combustion-engine vehicle.

10. The computer of claim 7, wherein at least two of the compression percentages are different from one another.

11. The computer of claim 7, wherein the instructions further include instructions to:
determine a maximum dynamic compression distance based on a target vehicle pulse index; and
in response to the maximum dynamic compression distance exceeding the available compression distance, determine a revised longitudinal distance, the revised longitudinal distance corresponding to the same structural landmarks as one of the proposed longitudinal distances.

12. The computer of claim 1, wherein the instructions further include instructions to determine a maximum dynamic compression distance for the front end of the vehicle during the predefined frontal impact based on a target vehicle pulse index.

13. The computer of claim 12, wherein the instructions further include instructions to receive the target vehicle pulse index as a user-selected input.

14. The computer of claim 1, wherein the instructions further include instructions to determine a predicted vehicle pulse index of the predefined frontal impact using the proposed longitudinal distances.

15. The computer of claim 14, wherein the predicted vehicle pulse index is maximum value of acceleration of a mass in a spring-mass system.

16. The computer of claim 14, wherein the instructions further include instructions to determine the predicted vehicle pulse index using the proposed longitudinal distances and a proposed vehicle mass of the vehicle.

17. The computer of claim 14, wherein the instructions further include instructions to determine the predicted vehicle pulse index based on the proposed longitudinal distances and a proposed engine mass of an engine of the vehicle.

18. The computer of claim 14, wherein the instructions further include instructions to:
determine an idealized two-step pulse characterizing the predefined frontal impact based on the proposed longitudinal distances; and
determine the predicted vehicle pulse index based on the idealized two-step pulse.

19. The computer of claim 1, wherein the instructions further include instructions to determine an idealized two-step pulse characterizing the predefined frontal impact based on the proposed longitudinal distances.

20. A method comprising:
receiving a plurality of proposed longitudinal distances for a vehicle being designed, the proposed longitudinal distances being measured along a longitudinal axis of the vehicle between structural landmarks in a front end of the vehicle; and
determining a predicted metric of a predefined frontal impact to the vehicle using the proposed longitudinal distances.
